(19) United States
(12) Patent Application Publication
(10) Pub. No.: US 2005/0228909 A1
(43) Pub. Date: Oct. 13, 2005

(54) Computer system capable of audio and video playback while in a non-booted state

(75) Inventors: Wen-Chi Chen, Jung-He City (TW); Chung-Wen Chen, Jung-He City (TW); Chun-Chang Yang, Jung-He City (TW)

Correspondence Address: Ladas & Parry, Suite 2100, 5670 Wilshire Boulevard, Los Angeles, CA, 90036-5679, US

(73) Assignee: MICRO-STAR INTERNATIONAL CO., LTD.

(21) Appl. No.: 11/096,332

(22) Filed: Mar. 30, 2005

(30) Foreign Application Priority Data
Apr. 8, 2004 (TW) 093109678

(51) Int. Cl. G06F 13/10

(52) U.S. Cl. 710/62; 710/14

(57) ABSTRACT

A computer system includes a reading device, a host computing device, an audio-and-video reproducing device, and a switching device. The reading device is operable so as to read information from a storage medium. The switching device is coupled to the reading device, the host computing device, and the audio-and-video reproducing device, and is operable in one of first and second switch states. The host computing device is operable so as to convert the information read by the reading device into audio and video output signals when the switching device is in the first switch state. The audio-and-video reproducing device is operable so as to convert the information read by the reading device into the audio and video output signals when the switching device is in the second switch state.

### CROSS-REFERENCE TO RELATED APPLICATION

This application claims priority of Taiwanese application no. 093109678, filed on Apr. 8, 2004.

### BACKGROUND OF THE INVENTION

1. Field of the Invention

The invention relates to a computer system, more particularly to a computer system that is capable of audio and video playback while in a non-booted state.

2. Description of the Related Art

In U.S. Pat. No. 6,266,714, there is disclosed a conventional computer system that includes an optical disc drive, a computing device and a playback device. The optical disc drive is operable so as to read information stored in an optical disc. The computing device is installed with an operating system that controls operation of the computing device. The playback device is operable so as to reproduce the information read by the optical disc drive when the operating system of the computing device is in a non-booted state.

The aforementioned conventional computer system is disadvantageous in that the only information stored in audio compact discs can be reproduced when the computing device is in the non-booted state.

### SUMMARY OF THE INVENTION

Therefore, the object of the present invention is to provide a computer system that is capable of overcoming the aforesaid drawback of the prior art.

According to the present invention, a computer system comprises a reading device, a host computing device, an audio-and-video reproducing device, and a switching device. The reading device is operable so as to read information from a storage medium. The switching device is coupled to the reading device, the host computing device, and the audio-and-video reproducing device, and is operable in one of a first switch state, where the switching device connects the reading device to the host computing device, and simultaneously disconnects the reading device from the audio-and-video reproducing device, and a second switch state, where the switching device connects the reading device to the audio-and-video reproducing device, and simultaneously disconnects the reading device from the host computing device. The host computing device is operable so as to convert the information read by the reading device into audio and video output signals when the switching device is in the first switch state. The audio-and-video reproducing device is operable so as to convert the information read by the reading device into the audio and video output signals when the switching device is in the second switch state. Accordingly, reproduction of the information in the storage medium is permitted even when the host computing device is in a non-booted state.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of a computer system according to the present invention;

FIG. 2 is a schematic circuit block diagram to illustrate an audio-and-video reproducing device of the preferred embodiment; and

FIG. 3 is a schematic view to illustrate a remote controller of the preferred embodiment.

### DETAILED DESCRIPTION OF THE PREFERRED EMBODIMENT

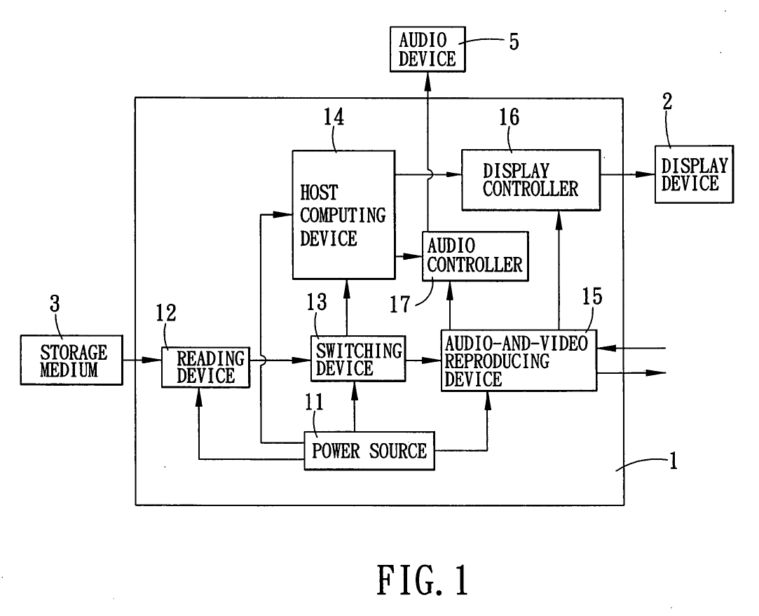

Referring to FIG. 1, the preferred embodiment of a computer system 1 according to this invention is shown to include a reading device 12, a host computing device 14, an audio-and-video reproducing device 15, and a switching device 13.

The computer system 1 of this embodiment may be one of a desktop personal computer and a notebook computer.

The reading device 12, such as a DVD drive or a CD-ROM drive, is operable so as to read information from a storage medium, such as an optical disc.

The switching device 13 is coupled to the reading device 12, the host computing device 14, and the audio-and-video reproducing device 15. In this embodiment, the switching device 13 is operable in one of a first switch state, where the switching device 13 connects the reading device 12 to the host computing device 14, and simultaneously disconnects the reading device 12 from the audio-and-video reproducing device 15, and a second switch state, where the switching device 13 connects the reading device 12 to the audio-and-video reproducing device 15, and simultaneously disconnects the reading device 12 from the host computing device 14.

The host computing device 14 is installed with an operating system for controlling operation of the host computing device 14 in a manner well-known in the art. In this embodiment, the host computing device 14 is operable so as to convert the information read by the reading device 12 into audio and video output signals when the switching device 13 is in the first switch state.

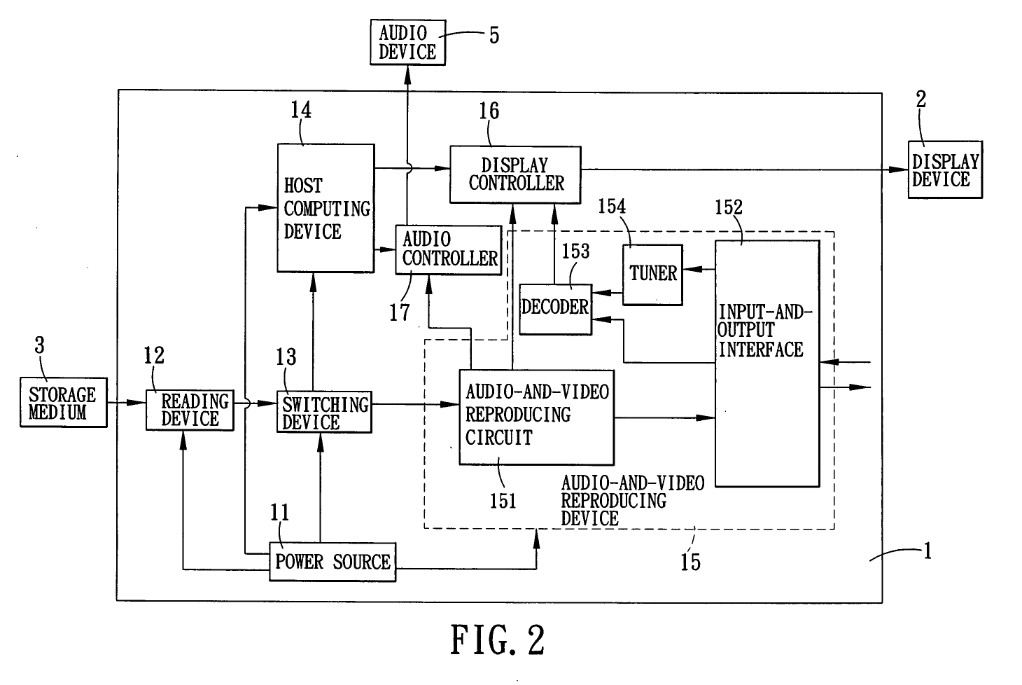

With further reference to FIG. 2, the audio-and-video reproducing device 15 includes an audio-and-video reproducing circuit 151 that is operable so as to convert the information read by the reading device 12 into the audio and video output signals when the switching device 13 is in the second switch state. As such, reproduction of the information in the storage medium 3 is permitted even when the operating system of the host computing device 14 is in a non-booted state. It is noted that the audio-and-video reproducing circuit 151 of the audio-and-video reproducing device 15 provides size scaling of the information read by the reading device 12 during conversion.

The computer system 1 further includes display and audio controllers 16, 17. The display controller 16 is coupled to the host computing device 14, and the audio-and-video reproducing circuit 151 of the audio-and-video reproducing device 15, and is adapted to be coupled to a display device 2. In this embodiment, the display controller 16 is operable so as to provide the video output signal generated by the host computing device 14 to the display device 2 when the switching device 13 is in the first switch state, and so as to provide the video output signal generated by the audio-and-video reproducing circuit 151 of the audio-and-video reproducing device 15 to the display device 2 when the switching device 13 is in the second switch state. The audio controller 17 is coupled to the host computing device 14, and the audio-and-video reproducing circuit 151 of the audio-and-video reproducing device 15, and is adapted to be coupled to an audio device 5. In this embodiment, the audio controller 17 is operable so as to provide the audio output signal generated by the host computing device 14 to the audio device 5 when the switching device 13 is in the first switch state, and so as to provide the audio output signal generated by the audio-and-video reproducing circuit 151 of the audio-and-video reproducing device 15 to the audio device 5 when the switching device 13 is in the second switch state.

The audio-and-video reproducing device 15 further includes an input-and-output interface 152, a decoder 153, and a tuner 154. The input-and-output interface 152 is coupled to the audio-and-video reproducing circuit 151 of the audio-and video reproducing device 15. In this embodiment, the input-and-output interface 152 is operable so as to provide the audio and video output signals from the audio-and-video reproducing circuit 151 of the audio-and video reproducing device 15 as an output, and so as to receive audio and video input signals from an external source (not shown). Preferably, the input-and-output interface 152 is one of an audio-video (AV) terminal and a S-video terminal. The decoder 153 is coupled between the input-and-output interface 152 and the display controller 16. In this embodiment, the decoder 152 is operable so as to decode the audio and video input signals received by the input-and-output interface 152. The display controller 16 is further operable so as to provide a decoded output from the decoder 153 to the display device 2. The tuner 154 is coupled between the decoder 153 and the input-and-output interface 152. In this embodiment, the tuner 154 is a television tuner.

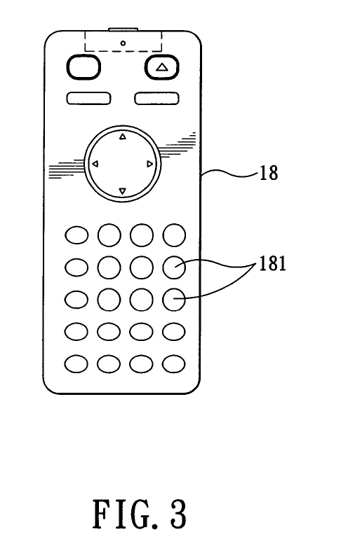

With further reference to FIG. 3, the computer system 1 further includes a remote controller 18. In this embodiment, the remote controller 18 includes a user input unit 181 that is operable so as to generate a user command signal, which is transmitted wirelessly, for controlling operation (e.g., channel, volume, and playback controls) of the host computing device 14 when the switching device 13 is in the first switch state, and for controlling operation (e.g., channel, volume, and playback controls) of the audio-and-video reproducing circuit 151 of the audio-and video reproducing device 15 when the switching device 13 is in the second switch state. In this embodiment, the remote controller 18 includes an infrared device. In an alternative embodiment, the remote controller 18 may include one of a radio frequency device and a Bluetooth device.

The computer system 1 further includes a power source 11 that is coupled to the reading device 12, the switching device 13, the host computing device 14, and the audio-and-video reproducing device 15.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A computer system, comprising:
a reading device operable so as to read information from a storage medium;
a host computing device;
an audio-and-video reproducing device; and
a switching device coupled to said reading device, said host computing device, and said audio-and-video reproducing device, said switching device being operable in one of a first switch state, where said switching device connects said reading device to said host computing device, and simultaneously disconnects said reading device from said audio-and-video reproducing device, and a second switch state, where said switching device connects said reading device to said audio-and-video reproducing device, and simultaneously disconnects said reading device from said host computing device,
wherein said host computing device is operable so as to convert the information read by said reading device into audio and video output signals when said switching device is in the first switch state,
wherein said audio-and-video reproducing device is operable so as to convert the information read by said reading device into the audio and video output signals when said switching device is in the second switch state, thereby permitting reproduction of the information in the storage medium even when said host computing device is in a non-booted state.

2. The computer system as claimed in claim 1, further comprising a remote controller operable so as to generate a user command signal, which is transmitted wirelessly, for controlling operation of said host computing device when said switching device is in the first switch state, and for controlling operation of said audio-and-video reproducing device when said switching device is in the second switch state.

3. The computer system as claimed in claim 1, further comprising:
a display controller coupled to said host computing device and said audio-and-video reproducing device, adapted to be coupled to a display device, and operable so as to provide the video output signal generated by said host computing device to the display device when said switching device is in the first switch state, and so as to provide the video output signal generated by said audio-and-video reproducing device to the display device when said switching device is in the second switch state; and
an audio controller coupled to said host computing device and said audio-and-video reproducing device, adapted to be coupled to an audio device, and operable so as to provide the audio output signal generated by said host computing device to the audio device when said switching device is in the first switch state, and so as to provide the audio output signal generated by said audio-and-video reproducing device to the audio device when said switching device is in the second switch state.

4. The computer system as claimed in claim 3, wherein said audio-and-video reproducing device includes an audio-and-video reproducing circuit that is coupled to said switching device and said display and audio controllers, and that converts the information read by said reading device into the audio and video signals.

5. The computer system as claimed in claim 4, wherein said audio-and-video reproducing device further includes an input-and-output interface coupled to said audio-and-video reproducing circuit of said audio-and-video reproducing device, and operable so as to provide the audio and video output signals from said audio-and-video reproducing circuit of said audio-and-video reproducing device as an output.

6. The computer system as claimed in claim 5, wherein said input-and-output interface is further operable so as to receive audio and video input signals from an external source.

7. The computer system as claimed in claim 6, wherein said audio-and-video reproducing device further includes a decoder coupled between said input-and-output interface and said display controller, and operable so as to decode the audio and video input signals received by said input-and-output interface, said display controller being further operable so as to provide a decoded output from said decoder to the display device.

8. The computer system as claimed in claim 7, wherein said audio-and-video reproducing device further includes a tuner coupled between said decoder and said input-and-output interface.

9. The computer system as claimed in claim 8, wherein said tuner is a television tuner.

10. The computer system as claimed in claim 1, wherein said reading device is an optical disc drive.
